(19) United States
(12) Patent Application Publication
(10) Pub. No.: US 2025/0142429 A1
(43) Pub. Date: May 1, 2025

(54) METHOD AND APPARATUS FOR COMMUNICATION ON UNLICENSED FREQUENCY BANDS IN WIRELESS COMMUNICATION SYSTEM

(71) Applicant: Samsung Electronics Co., Ltd., Gyeonggi-do (KR)

(72) Inventors: Miao ZHOU, Beijing (CN); Feifei SUN, Beijing (CN); Min WU, Beijing (CN)

(21) Appl. No.: 18/934,916

(22) Filed: Nov. 1, 2024

(30) Foreign Application Priority Data
Nov. 1, 2023 (CN) 202311443803.X

(51) Int. Cl. H04W 36/06; H04W 72/25

(52) U.S. Cl. CPC H04W 36/06; H04W 72/25

(57) ABSTRACT

The disclosure relates to a fifth generation (5G) or sixth generation (6G) communication system for supporting a higher data transmission rate. A method and an apparatus in a wireless communication system include determining first resources for a sidelink (SL) transmission, the first resources including multiple consecutive time units, determining whether the first resources include second resources unavailable for the SL transmission, and performing reselection of at least one of the second resources and at least one of third resources in a case that the first resources include the second resources, wherein the third resources include resources other than the second resources among the first resources.

### CROSS-REFERENCE TO RELATED APPLICATION(S)

This application is based on and claims priority under 35 U.S.C. § 119 (a) to Chinese Patent Application No. 202311443803 X, which was filed in the Chinese Patent Office on Nov. 1, 2023, the entire disclosure of which is incorporated herein by reference.

### BACKGROUND

### 1. Field

The disclosure relates generally to wireless communication technology, and more particularly, to a method and an apparatus for communication on unlicensed frequency bands in a wireless communication system.

### 2. Description of Related Art

Fifth generation (5G) mobile communication technologies define broad frequency bands such that high transmission rates and new services are possible, and can be implemented not only in sub 6 gigahertz (GHz) bands such as 3.5 GHz, but also in above 6 GHz bands referred to as millimeter wave (mmWave) bands including 28 GHz and 39 GHz bands. In addition, it has been considered to implement sixth generation (6G) mobile communication technologies referred to as beyond 5G systems in terahertz (THz) bands (e.g., 95 GHz to 3 THz bands) to achieve transmission rates fifty times faster than 5G mobile communication technologies and ultra-low latencies one-tenth of 5G mobile communication technologies.

Since the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multi input multi output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio-unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there is ongoing standardization in air interface architecture/protocol regarding technologies, such as industrial Internet of things (IIOT), for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying 2-step random access channel (RACH) procedures for NR. There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in THz bands of 6G mobile communication technologies, multi-antenna transmission technologies, such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

In 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, etc.

In 5G systems, hybrid frequency shift keying (FSK) and quadrature amplitude modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

In the LTE technology, sidelink (SL) communication includes direct device to device (D2D) communication and vehicle to outside communication (Vehicle to Vehicle/Infrastructure/Pedestrian/Network, collectively referred to as V2X), where the V2X communication is designed based on the D2D technology, is superior to the D2D in data rate, delay, reliability and link capacity, and is the most representative SL communication technology in LTE technology. In 5G systems, at present, SL communication mainly includes V2X communication.

As the evolution technology of LTE, 5G NR systems also include the further evolution of SL communication accordingly, and NR V2X technology is formulated and has superior performance in all aspects. 5G NR systems are expected to further expand the application scenarios of NR V2X to other broader application scenarios, e.g., commercial SL communication and public safety (PS) scenarios. The evolution of SL communication includes the direction of unlicensed frequency band, frequency range 2 (FR2), carrier aggregation, co-channel coexistence with LTE, etc., and also includes the support for technologies in other fields such as positioning.

When an SL communication system is the V2X system, a terminal or UE may be various types of terminals or UEs such as Vehicle, Infrastructure, and Pedestrian, etc.

In an LTE SL communication system and NR V2X system, the frequency domain resources used for SL communication are usually located in licensed frequency bands. Generally, it is assumed that there is minimal to no interference from other external communication systems on the frequency bands. However, for the SL communication system operating on unlicensed frequency bands, it is necessary to consider the interference of other communication systems on the unlicensed carriers, and to limit the interference of SL communication to other communication systems according to regulation.

In an NR-U system, listen before talk (LBT) is used as one of the typical technologies on the unlicensed frequency bands, in which a special frame structure is defined for the NR communication system on the unlicensed frequency bands, and the frame structure contains several gaps for LBT. A UE and a BS need to perform LBT before UL and DL transmission, and only after LBT is passed can they transmit all kinds of wireless signals/channels normally.

The SL communication system is restricted by laws and regulations when operating on the unlicensed frequency bands. After selecting the resources for SL transmission, if there is a gap exceeding a certain length before the transmission, the UE needs to perform LBT procedure first, and the transmission can be transmitted only when the LBT is successful, otherwise the transmission cannot be transmitted. Therefore, when the UE needs to transmit multiple transmissions (retransmissions) of an SL signal/channel or multiple SL signals/channels, to reduce the impact of potential LBT failure on the transmission, the UE can select multiple consecutive slots to transmit one or more SL signals/channels respectively in the resource allocation procedure referred to as multi-consecutive slots transmission (MCSt). Slots can also be replaced by other time units.

In the SL system on the licensed frequency bands, after selecting the transmission resources, the UE may detect that the resources reserved by other UEs overlap with the selected transmission resources, resulting in the unavailability of the selected transmission resources. In this case, the UE will reselect the unavailable transmission resources. For example, pre-emption and re-evaluation are two methods widely used on the licensed frequency bands, in which resource reselection is triggered based on the conflict between transmission resources and other UEs. This method can be applied to the unlicensed frequency bands. For the channel characteristics on the unlicensed frequency bands, however, the method is disadvantageous in that it fails to address when the selected transmission resources (including some of them) are unavailable due to LBT failure, and the method is designed for single slot transmission and does not adapt to communication based on MCSt accordingly.

Therefore, there is a need in the art for methods suitable for communication on the unlicensed frequency bands.

### SUMMARY

The disclosure has been made to address at least the above-mentioned problems and/or disadvantages and to provide at least the advantages described below.

Accordingly, an aspect of the disclosure is to provide a method and apparatus suitable for communication on the unlicensed frequency bands in a wireless communication system.

In accordance with an aspect of the disclosure, there is provided a method performed by a first user equipment (UE) in a wireless communication system, including determining first resources for an SL transmission, wherein the first resources include multiple consecutive time units, determining whether the first resources include second resources unavailable for the SL transmission, and performing reselection of at least one of the second resources and at least one of third resources in a case that the first resources include the second resources, wherein the third resources include resources other than the second resources among the first resources, and wherein performing the reselection of at least one of the second resources and at least one of the third resources includes at least one of: performing reselection of all of the first resources, performing reselection of at least one of the second resources and at least one of the third resources that is located before the at least one of the second resources among the first resources, performing reselection of at least one of the second resources and at least one of the third resources that is located after the at least one of the second resources among the first resources.

In accordance with an aspect of the disclosure, there is provided a method performed by a second user equipment (UE) in a wireless communication system, including determining fourth resources for an SL transmission; and determining whether to perform reselection of the fourth resources according to whether a third condition is satisfied, based on detecting that fifth resources overlap with the fourth resources, wherein the fifth resources include at least one of first resources indicated by a first UE, wherein the third condition is related to a priority of the fifth resources and/or the SL transmission of the second UE and/or whether the SL transmission is based on an MCSt.

In accordance with an aspect of the disclosure, there is provided a (UE including a transceiver, and a controller coupled to the transceiver and configured to perform the aforementioned methods.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates a wireless network according to an embodiment;

FIGS. 2A and 2B illustrate example wireless transmission and reception paths according to an embodiment;

FIG. 3A illustrates a UE according to an embodiment;

FIG. 3B illustrates a gNB according to an embodiment;

FIG. 4 illustrates a method performed by a first UE according to an embodiment;

FIG. 5 illustrates a method performed by a second UE according to an embodiment;

FIG. 6 illustrates a configuration of a UE according to an embodiment; and

FIG. 7 illustrates a configuration of a base station according to an embodiment.

### DETAILED DESCRIPTION

The following description with reference to the accompanying drawings is provided to assist in a comprehensive understanding of the disclosure. It includes various specific details to assist in that understanding but these are to be regarded as merely examples. Accordingly, those of ordinary skill in the art will recognize that various changes and modifications of the various embodiments described herein can be made without departing from the scope and spirit of the disclosure. Descriptions of well-known functions and constructions may be omitted for the sake of clarity and conciseness.

Terms described below are terms defined in consideration of functions in the disclosure, which may vary according to intentions or customs of users and providers. Therefore, the definition should be made based on the content throughout this specification.

Some components are exaggerated, omitted, or schematically illustrated in the accompanying drawings. The size of each component does not fully reflect the actual size. In each drawing, the same reference numerals are given to the same or corresponding components.

Embodiments of the disclosure enable a constitution of the disclosure to be complete and are provided to fully inform the scope of the disclosure to those of ordinary skill in the art to which the disclosure pertains.

It is to be understood that the singular forms a, an, and the include plural referents unless the context clearly dictates otherwise. Thus, for example, reference to a component surface includes reference to one or more of such surfaces.

The term include or may include refers to the existence of a corresponding disclosed function, operation or component which can be used in various embodiments of the present disclosure and does not limit one or more additional functions, operations, or components. The terms such as include and/or have may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term or used herein includes any or all of combinations of listed words. For example, the expression A or B may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the same meanings as the contextual meanings in the relevant field of art, and are not to be interpreted to have ideal or excessively formal meanings unless clearly defined in the present disclosure.

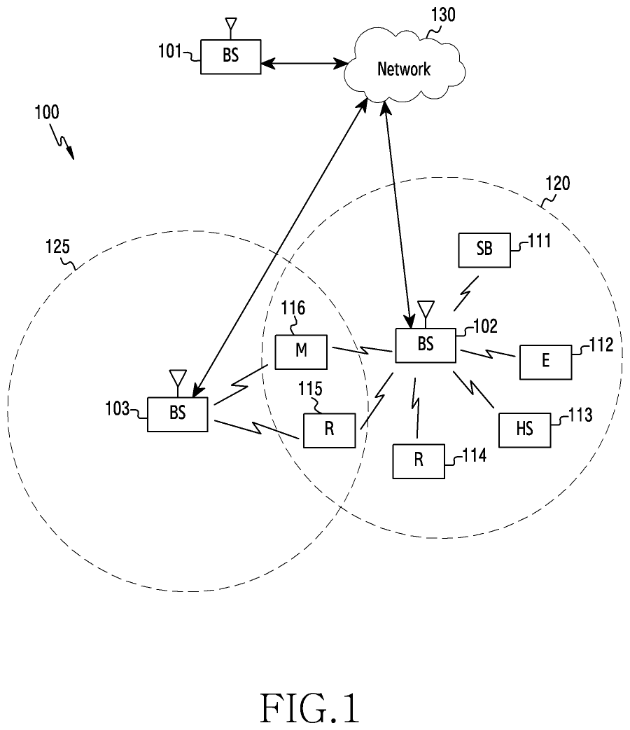

FIG. 1 illustrates a wireless network 100 according to an embodiment.

Referring to FIG. 1, the wireless network 100 includes a gNodeB (gNB) 101, a gNB 102, and a gNB 103. gNB 101 communicates with gNB 102 and gNB 103. gNB 101 also communicates with at least one Internet protocol (IP) network 130, such as the Internet, a private IP network, or other data networks.

Depending on a type of the network, other well-known terms such as BS or access point can be used instead of gNodeB or gNB. For convenience, the terms gNodeB and gNB are used in this patent document to refer to network infrastructure components that provide wireless access for remote terminals. And, depending on the type of the network, other well-known terms such as mobile station, user station, remote terminal, wireless terminal or user apparatus can be used instead of user equipment or UE. For convenience, the terms user equipment and UE are used in this patent document to refer to remote wireless devices that wirelessly access the gNB, whether the UE is a mobile device (such as a mobile phone or a smart phone) or a fixed device (such as a desktop computer or a vending machine).

The gNB 102 provides wireless broadband access to the network 130 for a first plurality of UEs within a coverage area 120 of gNB 102. The first plurality of UEs include a UE which may be located in a small business (SB) 111, a UE which may be located in an enterprise (E) 112, a UE which may be located in a WiFi hotspot (HS) 113, a UE which may be located in a first residence (R) 114, a UE which may be located in a second residence (R) 115, and a UE which may be a mobile device (M) 116, such as a cellular phone, a wireless laptop computer, a wireless personal data assistant (PDA), etc. The gNB 103 provides wireless broadband access to network 130 for a second plurality of UEs within a coverage area 125 of gNB 103. The second plurality of UEs includes a UE 115 and a UE 116. One or more of gNBs 101-103 can communicate with each other and with UEs 111-116 using 5G, long term evolution (LTE), LTE-A, WiMAX or other advanced wireless communication technologies.

The dashed lines show approximate ranges of the coverage areas 120 and 125, and the ranges are shown as approximate circles merely for illustration and explanation purposes. The coverage areas associated with the gNBs, such as the coverage areas 120 and 125, may have other shapes, including irregular shapes, depending on configurations of the gNBs and changes in the radio environment associated with natural obstacles and man-made obstacles.

One or more of gNB 101, gNB 102, and gNB 103 include a two-dimensional (2D) antenna array as described herein. One or more of gNB 101, gNB 102, and gNB 103 support codebook designs and structures for systems with 2D antenna arrays.

Various changes can be made to FIG. 1. That is, the wireless network 100 can include any number of gNBs and any number of UEs in any suitable arrangement, for example. The gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

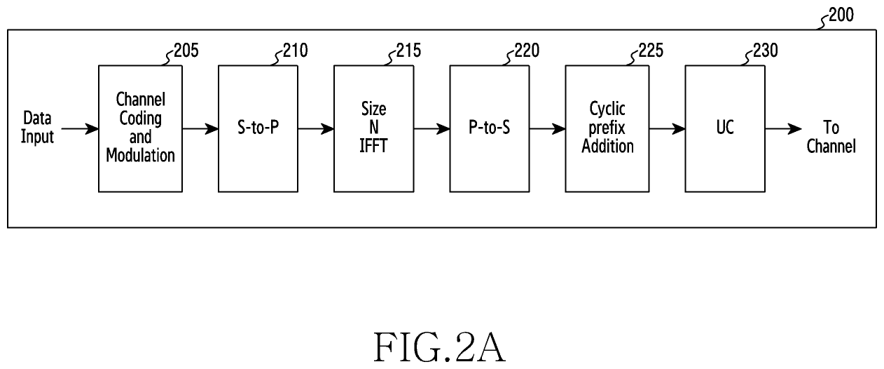

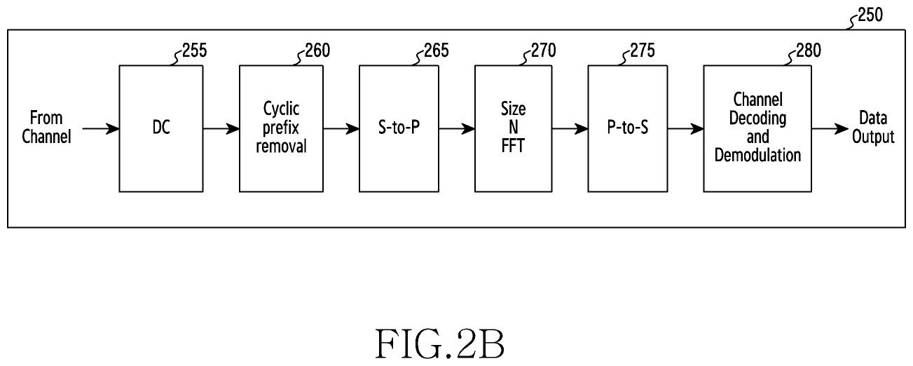

FIGS. 2A and 2B illustrate wireless transmission and reception paths according to an embodiment. The transmission path 200 may be implemented in a gNB, such as gNB 102, and the reception path 250 may be implemented in a UE, such as UE 116. However, the reception path 250 can be implemented in a gNB and the transmission path 200 can be implemented in a UE. The reception path 250 is configured to support codebook designs and structures for systems with 2D antenna arrays as described herein.

Referring to FIG. 2A, the transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230.

Referring to FIG. 2B, the reception path 250 includes a down-converter (DC) 255, a cyclic prefix removal block 260, an S-to-P block 265, a size N fast Fourier transform (FFT) block 270, a P-to-S block 275, and a channel decoding and demodulation block 280.

In the transmission path 200, the channel coding and modulation block 205 receives a set of information bits, applies low density parity check (LDPC) coding), and modulates the input bits, such as using quadrature phase shift keying (QPSK) or quadrature amplitude modulation (QAM) to generate a sequence of frequency-domain modulated symbols.

The S-to-P block 210 demultiplexes serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The P-to-S block 220 multiplexes parallel time-domain output symbols from the Size N IFFT block 215 to generate a serial time-domain signal. The cyclic prefix addition block 225 inserts a cyclic prefix into the time-domain signal. The up-converter 230 up-converts the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The S-to-P block 265 converts the time-domain baseband signal into a parallel time-domain signal. The Size N FFT block 270 performs an FFT algorithm to generate N parallel frequency-domain signals. The P-to-S block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink (DL) and may implement a reception path 250 similar to that for receiving from UEs 111-116 in the uplink (UL). Similarly, each of UEs 111-116 may implement a transmission path 200 for transmitting to gNBs 101-103 in the UL and may implement a reception path 250 for receiving from gNBs 101-103 in the DL.

Each of the components in FIGS. 2A and 2B can be implemented using only hardware, or using a combination of hardware and software/firmware. For example, at least some of the components in FIGS. 2A and 2B may be implemented in software, while other components may be implemented in configurable hardware or a combination of software and configurable hardware. The FFT block 270 and IFFT block 215 may be implemented as configurable software algorithms, in which the value of the size N may be modified according to the implementation.

Although described as using FFT and IFFT, this is only illustrative and other types of transforms can be used, such as discrete Fourier transform (DFT) and inverse discrete Fourier transform (IDFT) functions. For DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. FIGS. 2A and 2B illustrate examples of types of transmission and reception paths that can be used in a wireless network. Any other suitable architecture can be used to support wireless communication in a wireless network.

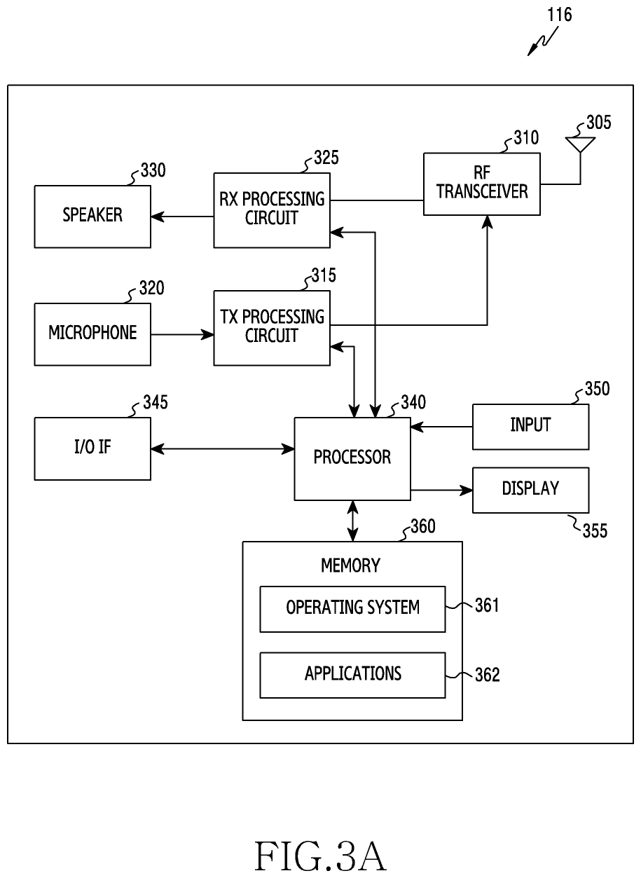

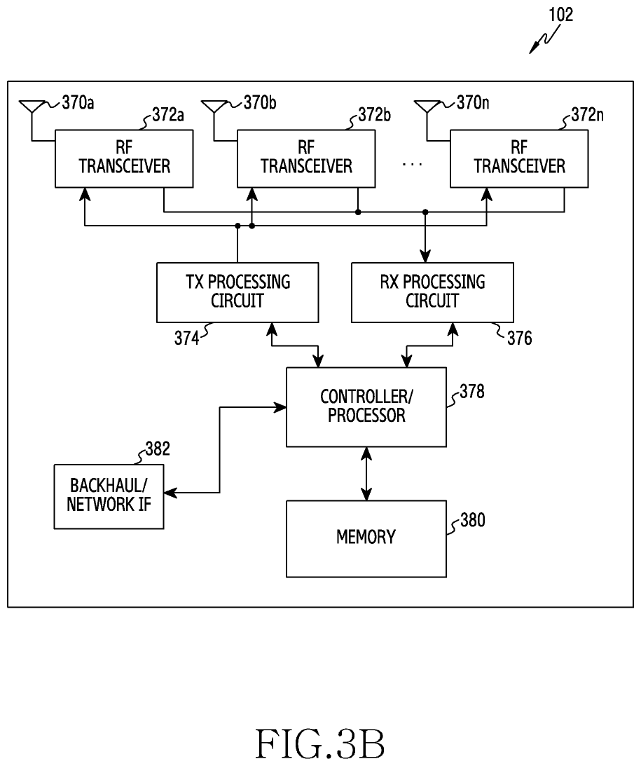

FIG. 3A illustrates a UE 116 according to an embodiment.

Referring to FIG. 3A, UE 116 includes an antenna 305, a radio frequency (RF) transceiver 310, a transmission (TX) processing circuit 315, a microphone 320, a reception (RX) processing circuit 325 a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal which is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. The processor/controller 340 includes at least one microprocessor or microcontroller.

The processor/controller 340 is also capable of executing other processes and programs residing in the memory 360, such as operations for channel quality measurement and reporting for systems with 2D antenna arrays as described herein. The processor/controller 340 can move data into or out of the memory 360 as required by an execution process and is configured to execute the application 362 based on the OS 361 or in response to signals received from the gNB or the operator. The processor/controller 340 is also coupled to an I/O interface 345, which provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates a of UE 116, various changes can be made to FIG. 3A. For example, various components in FIG. 3A can be combined, further subdivided or omitted, and additional components can be added according to specific requirements. For example, the processor/controller 340 can be divided into a plurality of processors, such as one or more central processing units (CPUs) and one or more graphics processing units (GPUs). Although FIG. 3A illustrates that the UE 116 is configured as a mobile phone or a smart phone, UEs can be configured to operate as other types of mobile or fixed devices.

FIG. 3B illustrates a gNB 102 according to an embodiment. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

Referring to FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n includes a 2D antenna array. gNB 102 also includes a controller/processor 378, a memory 380, and a backhaul or network interface 382.

The RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. The TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a blind interference sensing (BIS) process such as that performed through a BIS algorithm, and decode a received signal from which an interference signal is subtracted. A controller/processor 378 may support any of a variety of other functions in gNB 102. The controller/processor 378 includes at least one microprocessor or microcontroller.

The controller/processor 378 is also capable of executing programs and other processes residing in the memory 380, such as a basic operating system (OS). The controller/processor 378 can also support channel quality measurement and reporting for systems with 2D antenna arrays as described herein. The controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows the gNB 102 to communicate with other devices or systems through a backhaul connection or through a network. The backhaul or network interface 382 can support communication over any suitable wired or wireless connection(s). For example, when the gNB 102 is implemented as a part of a cellular communication system, such as a cellular communication system supporting 5G or new radio access technology or NR, LTE or LTE-A, the backhaul or network interface 382 can allow the gNB 102 to communicate with other gNBs through wired or wireless backhaul connections. When the gNB 102 is implemented as an access point, the backhaul or network interface 382 can allow the gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions is configured to cause the controller/processor 378 to execute the BIS process and decode the received signal after subtracting at least one interference signal determined by the BIS algorithm.

The transmission and reception paths of gNB 102 (implemented using RF transceivers 372a-372n, TX processing circuit 374 and/or RX processing circuit 376) support aggregated communication with frequency duplex division (FDD) cells and time division duplex (TDD) cells.

Although FIG. 3B illustrates a of gNB 102, various changes may be made to FIG. 3B. For example, gNB 102 can include any number of each component shown in FIG. 3A. The access point can include many backhaul or network interfaces 382, and the controller/processor 378 can support routing functions to route data between different network addresses. Although shown as including a single instance of the TX processing circuit 374 and a single instance of the RX processing circuit 376, gNB 102 can include multiple instances of each (such as one for each RF transceiver).

Information configured by a BS, by signaling, by a higher layer, and preconfigured information include a set of configuration information, multiple sets of configuration information, where the UE selects a set of configuration information therefrom for use according to a predefined condition, a set of configuration information including multiple subsets, where the UE selects a subset therefrom for use according to a predefined condition. Herein, “lower than a threshold” may also be replaced by “lower than or equal to a threshold”, “greater than a threshold” may also be replaced by “greater than or equal to a threshold”, “less than or equal to” may also be replaced by “less than”, and “larger than or equal to” may also be replaced by “larger than”, and vice versa.

A part of the technical schemes provided are specifically described based on the V2X system, but their application scenarios should not be limited to the V2X system in SL communication but may also be applied to other SL transmission systems. For example, the design based on V2X subchannels in the following embodiments may also be used for D2D subchannels or other subchannels for SL transmission. The V2X resource pool herein may also be replaced by the D2D resource pool in other SL transmission systems such as the D2D.

A BS herein may also be replaced by other nodes, such as SL nodes, and a specific example is an infrastructure UE in the SL system. Any mechanism applicable to the BS may also be similarly used in the scenario where the BS is replaced by other SL nodes.

A slot herein may also be replaced by a time unit, a candidate slot may also be replaced by a candidate time unit, and a candidate slot resource may also be replaced by a candidate time unit resource. The time unit includes a specific time length, such as several consecutive symbols.

The slot may be either a subframe or slot in a physical sense, or a subframe or slot in a logical sense. Specifically, the subframe or slot in the logical sense is a subframe or slot corresponding to a resource pool for SL communication. For example, in the V2X system, the resource pool is defined by a repeated bitmap mapped to a specific slot set, which may be all slots or all other slots except some specific slots (such as slots for transmitting a master information block (MIB)/system information block (SIB)). A slot indicated as “1” in the bitmap may be used for V2X transmission and pertains to slots corresponding to the V2X resource pool. A slot indicated as “0” cannot be used for V2X transmission and does not pertain to slots corresponding to the V2X resource pool.

The difference between the subframes or slots in the physical sense or those in the logical sense is illustrated by a typical application scenario below. When calculating the time-domain gap between two specific channels/messages (e.g., a PSSCH carrying SL data and a PSFCH carrying corresponding feedback information), and it is assumed that the gap is N slots, if calculating subframes or slots in the physical sense, the N slots correspond to the absolute time length of N*x milliseconds in time domain, and x is the time length of a physical slot (subframe) under the numerology of the scenario, in milliseconds; otherwise, if calculating subframes or slots in the logical sense, taking an SL resource pool defined by a bitmap as a, the gap of N slots correspond to N slots indicated as “1” in the bitmap, and the absolute time length of the gap varies with the specific configuration of the SL communication resource pool, rather than a fixed value.

A slot herein may be a complete slot or several symbols corresponding to an SL communication in a slot. For example, when the SL communication is configured to be performed on the X1-X2-th symbols in each slot, in this scenario, a slot in the following embodiments refers to the X1-X2-th symbols in a slot; for another example, when the SL communication is configured to be transmitted in a mini-slot, in this scenario, a slot in the following embodiments refers to the mini-slot defined or configured in the SL system, rather than the slot in the NR system; for still another example, when the SL communication is configured as symbol-level transmission, in this scenario, a slot in the embodiments may be replaced by a symbol, or may be replaced by N symbols which are time-domain granularity of the symbol-level transmission.

Herein, a level of a priority is indicated by its value. In SL communication, a higher value of a priority generally corresponds to a lower priority. Correspondingly, a priority being greater than a threshold can be understood as a value of the priority being lower than a threshold, and vice versa.

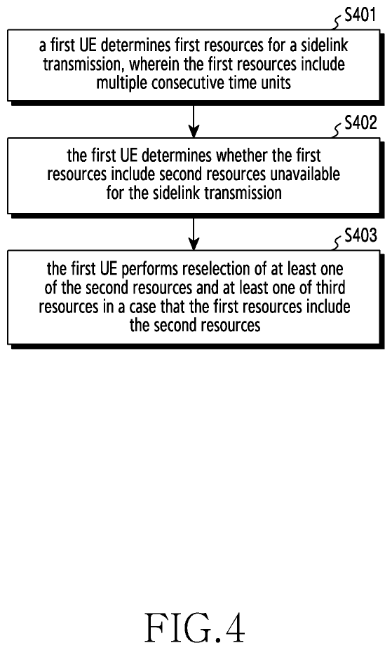

FIG. 4 illustrates a method performed by a first UE according to an embodiment. In step S401, the first UE determines first resources for an SL transmission, wherein the first resources include multiple consecutive time units (or resources on multiple consecutive time units). In step S402, the first UE determines whether the first resources include second resources unavailable for the SL transmission. In step S403, the first UE performs reselection of at least one of the second resources and at least one of third resources in a case that the first resources include the second resources. One of the second/third resources may be a resource corresponding to at least one of time units corresponding to the second/third resources.

The first UE determines first resources for its SL transmission, and then determines whether at least one of the first resources is unavailable according to a first condition. One of the first resources may be a resource corresponding to at least one of the time units corresponding to the first resources. For the convenience of description, unavailable resources are referred to as second resources, and the remaining available resources among the first resources are referred to as third resources. If the first resources include unavailable resources (second resources), then:
the first UE reselects the second resources and/or the third resources, wherein the reselecting includes re-evaluation and/or pre-emption, and transmits its SL transmission on the reselected second resources and/or third resources;
or, the first UE determines whether to reselect the second resources and/or the third resources, optionally according to a second condition. If the first UE is required to reselect the second resources and/or the third resources, the UE reselects the second resources and/or the third resources and transmits its SL transmission on the reselected second resources and/or the third resources; otherwise, if it is determined that the second resources and/or the third resources do not need to be re-selected, its SL transmission is transmitted on the determined second resources and/or third resources.

If at least one of the first resources satisfies the first condition, the at least one of the first resources is determined to be unavailable (which can also be understood as determining that the at least one resource is the second resource); otherwise, the resources among the first resources are all determined to be available (which can also be understood as resources that do not satisfy the first condition being the third resources).

The first condition includes at least one of:
detecting that resources indicated by other UEs overlap with the at least one resource; the indicating includes indicating in SL control information (SCI) transmitted by other UEs and/or indicating in inter-UE coordination (IUC) information received by the first UE, and the overlapping includes partial overlapping;
failing to transmit on the at least one resource due to an LBT failure; for example, a failure of LBT performed before a slot where the at least one resource is located, and/or a failure of LBT performed before at least one starting location of the slot where the at least one resource is located, and/or a failure of performed LBT corresponding to the at least one resource, etc., causes the first UE to be unable to transmit on the resource.

The conditions as to detecting that the resources indicated by other UEs overlap with the at least one resource, optionally, further include at least one of:
a priority corresponding to the resources indicated by other UEs being greater than a priority of the SL transmission of the first UE; it is greater than a priority of at least one or any SL transmission of the first UE on the at least one resource, and/or greater than a priority corresponding to any of the first resources;
an offset between the priority of the SL transmission of the first UE and the priority corresponding to the resources indicated by other UEs is greater than or equal to a first threshold; The priority corresponding to the resources indicated by other UEs is greater than the priority of the SL transmission of the first UE, and the offset of the priority corresponding to the resources indicated by other UEs minus the priority of the SL transmission of the first UE is greater than or equal to the first threshold;
the priority corresponding to the resources indicated by other UEs is greater than or equal to a second threshold, and/or the priority of the SL transmission of the first UE is lower than or equal to a third threshold;
a number of slots or other time units corresponding to the first resources is lower than or equal to a fourth threshold;
any of second conditions; the second resources in the second conditions can be resources that satisfy at least one of the above other conditions, and the third resources can be resources that does not satisfy at least one of the above other conditions.

The priority of the SL transmission of the first UE includes the priority of any or at least one SL transmission of the first UE on the first resources, and/or the highest/lowest priority among multiple priorities of any or at least one SL transmission of the first UE on the first resources, and/or the priority of any or at least one SL transmission of the first UE on the at least one resource, and/or the highest/lowest priority among priorities of any or at least one SL transmission of the first UE on the at least one resource. The priority corresponding to the resources indicated by other UEs includes the priority corresponding to each of multiple resources indicated by other UEs, and/or the priority corresponding to the resources indicated by other UEs includes the highest/lowest priority among priorities corresponding to each of multiple resources indicated by other UEs.

The first threshold, the second threshold, the third threshold and the fourth threshold are (pre) configured and/or (pre) defined, for example, configured by RRC, and may be thresholds related to MCSt, for example, priority thresholds, priority offset thresholds, or slot number thresholds corresponding to whether to reselect resources when MCSt transmission resources conflict.

At least one/any of the first conditions and at least one/any of the conditions with regard to detecting that the resources indicated by other UEs overlap with the at least one resource can be determined whether to be used based on configuration (e.g. higher layer/BS/pre-configuration). If the first UE is configured with multiple first conditions, which first conditions to be used can be further determined according to the LBT type corresponding to the SL transmission on the first resources, for example, LBT type 1 or 2, and for another example, LBT type 2A/2B/2C.

If at least one second resource and/or third resource satisfies a second condition, the first UE determines to reselect at least one second resource and/or third resource; otherwise, the at least one second resource and/or the third resource is not reselected. At least one second resource and/or third resource may be a second resource corresponding to at least one slot or other time unit and/or a third resource corresponding to at least one slot or other time unit.

The second condition includes at least one of:
at least one of a number of resources included in the second resources, a number of slots corresponding to the second resources and a number of consecutive slots corresponding to the second resources being greater than or equal to a fifth threshold;
at least one of a number of resources included in the third resources, a number of slots corresponding to the third resources, a number of consecutive slots corresponding to the third resources, a number of earliest consecutive slots corresponding to the third resources, a number of latest consecutive slots corresponding to the third resources and a maximum number of the consecutive slots corresponding to the third resources being lower than or equal to a sixth threshold;
locations of the second resources and/or the third resources being at least one of: at a starting slot or at least one starting slot or multiple consecutive starting slots of the first resources, at an ending slot or at least one ending slot or multiple consecutive ending slots of the first resources, and not at at least one starting slot or multiple consecutive starting slots or at least one ending slot or multiple consecutive ending slots of the first resources.

The fifth threshold and the sixth threshold are (pre) configured and/or (pre) defined, for example, configured by RRC, and may be thresholds related to MCSt, for example, resource number thresholds or slot number thresholds corresponding to whether to reselect resources when MCSt transmission resources conflict.

At least one/any of the second conditions can be determined whether to be used based on the configuration (e.g., higher layer/BS/pre-configuration). If the first UE is configured with multiple second conditions, which second conditions to be used can be further determined according to the LBT type corresponding to the SL transmission on the first resources, for example, LBT type 1 or 2, and for another example, LBT type 2A/2B/2C.

In an embodiment of the specification, there is no defined chronological relationship between the UE behaviors of the first UE determining whether to reselect at least one second and/or third resource and the first UE determining which resources are the second and/or third resources. For example, the first UE may first determine the second resources according to whether the LBT fails and whether they overlap with the resources indicated by other UEs, and then determine whether to reselect at least one second resource according to a number and/or locations of slots corresponding to the second resources; In another example, the first UE determines that the second resources need to be reselected according to the priority corresponding to the first resources being lower than any of the aforementioned thresholds, and then determines which resources are the second resources.

The first UE determining to perform resource reselection of at least one second resource and/or third resource further includes performing the resource reselection by using at least one of:
performing the resource reselection of all resources included in the first resources. A specific example is that the first resources determined by the first UE include resources on five slots [n, n+1, . . . n+4], in which the resource on slot n+1 is a second resource that needs to be re-selected, and the first UE reselects the resources on all five slots, for example, the reselected resources are resources on slots [n+6, n+7, . . . n+10];
reselecting the at least one second resource. The method is used when the at least one second resource is unavailable because it overlaps with resources indicated by other UEs. A specific example is that the first UE includes resources on five slots [n, n+1, . . . n+4], in which the resource on slot n+1 is a second resource that needs to be re-selected, and the first UE reselects the resource on slot n+1 without reselecting the resources on the other four slots, for example, the reselected resources are the resources on slots n, n+2, n+3, n+4 and n+5, where the selected resources on slots n, n+2, n+3 and n+4 can be the same as the resources before reselection;
reselecting the at least one second resource and resources located before the at least one second resource among the first resources. The method is used when the at least one second resource is unavailable due to an LBT failure. The resources before the at least one second resource may include third resources and/or other second resources. A specific example is that the first UE includes resources on five slots [n, n+1, . . . n+4], in which the resource on slot n+2 is a second resource that needs to be re-selected, and the first UE reselects the resource on slot n+2 and the resources before slot n+2 (i.e., on slots n and n+1), for example, the reselected resources are resources on slots [n+3, n+4, . . . n+7], where the selected resources on slots n+3 and n+4 can be the same as the resources before reselection;
reselecting the at least one second resource and resources located after the at least one second resource among the first resources. The method is used when the at least one second resource is unavailable because it overlaps with resources indicated by other UEs. The resources after the at least one second resource may include third resources and/or other second resources. A specific example is that the first UE includes resources on five slots [n, n+1, . . . n+4], in which the resource on slot n+3 is a second resource that needs to be re-selected, and the first UE reselects the resource on slot n+3 and the resource after slot n+3 (i.e., on slot n+4), for example, the reselected resources are resources on slots [n−2, n−1, . . . n+2], where the selected resources on slots n to n+2 can be the same as the resources before reselection.

At least one/any of the above resource reselection methods can be determined whether to be used based on configuration (e.g., higher layer/BS/pre-configuration). If the first UE is configured with multiple methods, which methods to be used can be further determined according to the LBT type corresponding to the SL transmission on the first resources, for example, LBT type 1 or 2, and for another example, LBT type 2A/2B/2C.

The first UE determining to perform the resource reselection of at least one second resource and/or third resource further includes determining the reselected resources according to at least one of:
preferentially selecting candidate resources on consecutive slots in the reselection procedure. Compared with the resource selection procedure before reselection, the first UE increases the used reference signal received power (RSRP) threshold in the resource reselection. The extent of increase can be a (pre) configured/(pre) defined value, and the value of the threshold can be increased every time the resource reselection is performed;
preferentially selecting candidate resources that are continuous in time with other selected resources in the reselection procedure, wherein the selected resources include second resources and/or third resources that are not reselected, and/or transmission resources other than the first resources selected by the first UE for transmission; continuity in time includes continuity after the other selected resources and continuity before the other selected resources. In the reselection procedure, if the candidate resources are continuous in time with other selected resources, the value of the RSRP threshold is increased, which can be an RSRP threshold used when whether the candidate resources should be included in a candidate resource set and/or excluded from the candidate resource set is determined; otherwise, the value of the RSRP threshold is not adjusted. It should be noted that in the resource selection procedure, the UE can adjust the value of the RSRP threshold when the number of selected candidate resources is less than a threshold (for example, the RSRP threshold is increased by 3 dB). This adjustment based on the number of candidate resources and the above adjustment based on whether the candidate resources are continuous in time can coexist, that is, when the conditions corresponding to the two adjustments are satisfied respectively, the UE accordingly increases the RSRP threshold respectively.

In the reselection procedure, the method for the first UE to determine the reselected resources further includes at least one of:
if the candidate resources are before the selected resources, including being before the selected resources and continuous in time with the selected resources; and a gap between a starting location of the candidate resources and a time point at which the UE is triggered to perform the reselection (including re-evaluation and pre-emption) or a time point at which the UE detects the unavailable second resources or a time point at which the UE determines that the second resources and/or the third resources need to be reselected is greater than or equal to a seventh threshold; the candidate resources can be selected. The seventh threshold in the method can be used in combination with the definition of the time gap regarding the processing delay in wireless communication, for example, the candidate resources can only be used if the time gap corresponding to the seventh threshold and the time gap in wireless communication are satisfied; the definition of the time gap regarding the processing delay in wireless communication can also be replaced;
if the candidate resources are after the selected resources, including being after the selected resources and continuous in time with the selected resources; and the gap between the starting location of the candidate resources and the time point at which the UE is triggered to perform the reselection (including re-evaluation and pre-emption) or the time point at which the UE detects the unavailable second resources or the time point at which the UE determines that the second resources and/or the third resources need to be reselected is greater than or equal to an eighth threshold; the candidate resources can be selected. The eighth threshold in the method can replace the definition of the time gap regarding the processing delay in wireless communication.

The seventh threshold and the eighth threshold may be thresholds corresponding to the processing delay, or thresholds of delay for performing LBT, or thresholds corresponding to a total delay of both; The seventh and eighth thresholds are related to the delay for performing LBT when there are no other selected resources that are continuous in time before the candidate resources, otherwise, they are not related to the delay for performing LBT.

Any of the above methods can be used in combination with other existing methods in the resource reselection procedure, and can also replace other existing methods.

In the reselection procedure, the method for the first UE to determine the reselected resources further includes at least one of:
if the candidate resources are after the selected resources, including being after the selected resources and continuous in time with the selected resources; and the candidate resources are within a time range of channel occupancy (CO) initiated or shared by the first UE; the candidate resources can be selected;
if the candidate resources are outside the time range of the CO initiated or shared by the first UE, for example, after the end of the CO; then when a time gap between the candidate resources and other transmission resources selected by the first UE and/or resources indicated by other UEs that are detected by the first UE is greater than or equal to a ninth threshold, the candidate resources can be selected, otherwise the candidate resources cannot be selected. If the candidate resources are after other transmission resources selected by the first UE and/or resources indicated by other UEs that are detected, when a time gap between the starting location of the candidate resources and an ending location of other transmission resources selected by the first UE and/or an ending location of the resources indicated by other UEs that are detected by the first UE is greater than or equal to the ninth threshold, the candidate resources can be selected, otherwise the candidate resources cannot be selected.

The ninth threshold can be a delay threshold corresponding to LBT, and It can be a delay threshold corresponding to type 1 LBT, for example, the ninth threshold corresponds to a time length for the first UE to perform type 1 LBT, which is used to initiate a new CO.

Any of the above methods can be used in combination with other existing methods in the resource reselection procedure, such as resource exclusion based on SCI of other UEs, resource exclusion based on own transmission, etc., and can also replace other existing methods.

At least one/any of the above methods for determining the reselected resources can be determined whether to be used based on configuration (e.g., higher layer/BS/pre-configuration). If the first UE is configured with multiple methods, which methods to be used can be further determined according to the LBT type corresponding to the SL transmission on the first resources, for example, LBT type 1 or 2, LBT type 1 or 2 depending on whether backoff is performed or not. And for another example, LBT type 2A/2B/2C according to listen time length and backoff method.

The first UE determining to perform the resource reselection of at least one second resource and/or third resource further includes at least one of:

if the second resources are unavailable due to an LBT failure, all candidate resources on slots for the LBT failure and/or slots where resources corresponding to the LBT failure are located are excluded when selecting the candidate resources.

The first UE determining not to perform the resource reselection of the second resources and/or the third resources and to transmit its SL transmission on the determined second resources and/or third resources further includes:

if the second resources are unavailable because they overlap with the resources indicated by the second UE, transmitting signaling to the second UE, which is used to indicate the second UE to reselect the resources. Information indicated in the signaling includes at least one of:

at least one of the first resources, the second resources and the third resources, which can be used to inform the second UE of information of the resources that the first UE will use for transmission, so as to avoid the conflict between the second UE and the first UE after reselecting the resources;
an indication on whether the transmission of the first UE is based on MCSt;
a priority corresponding to at least one of the first resources, the second resources and the third resources.

The first UE determining not to perform the resource reselection of the second resources and/or the third resources and to transmit its SL transmission (e.g., physical sidelink shared channel (PSSCH) and its associated physical sidelink control channel (PSCCH)) on the determined second resources and/or third resources further includes that when indicating the priority corresponding to the SL transmission in SCI associated with the SL transmission, the indicated priority is based on at least one of:
if the priority corresponding to the SL transmission is lower than or equal to a tenth threshold, setting the indicated priority as the tenth threshold; otherwise, indicating the priority corresponding to the SL transmission;
the indicated priority being the priority corresponding to the SL transmission plus an offset, wherein the offset can be (pre) configured and/or (pre) defined, and can be a priority offset corresponding to MCSt;
if transmissions included in the SL transmissions corresponds to multiple priorities, setting a priority of each or at least one of the SL transmissions as the highest priority or the lowest priority among the multiple priorities.
at least one/any of the above methods corresponding to the indicated priority can be determined whether to be used based on configuration (e.g. higher layer/BS/pre-configuration). If the first UE is configured with multiple methods, which methods to be used can be further determined according to the LBT type corresponding to the SL transmission on the first resources, for example, LBT type 1 or 2, and for another example, LBT type 2A/2B/2C.

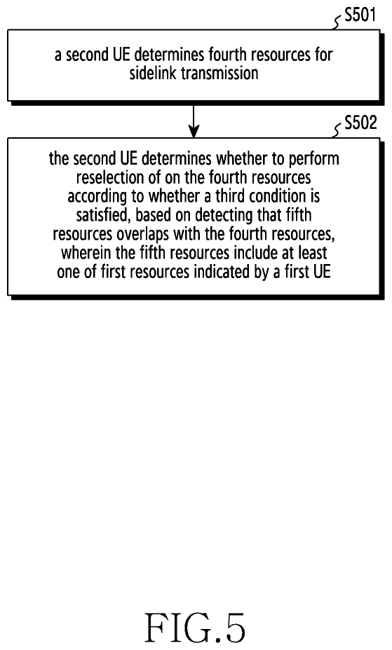

FIG. 5 illustrates a method performed by a second UE according to an embodiment. In step S501, the second UE determines fourth resources for SL transmission. In step S502, the second UE determines whether to perform reselection of the fourth resources according to whether a third condition is satisfied, based on detecting that fifth resources overlaps with the fourth resources, wherein the fifth resources include at least one of first resources indicated by a first UE.

In another exemplary embodiment, the second UE determines the fourth resources for its SL transmission and detects that at least one of the first resources indicated by the first UE overlaps with the fourth resources, and the second UE determines whether to reselect the fourth resources according to the third condition. If the second UE is required to reselect the fourth resources, reselect the fourth resources and transmit its SL transmission on the reselected fourth resources; otherwise, if it is determined that the fourth resources do not need to be re-selected, its SL transmission is transmitted on the determined fourth resources. For convenience of description, at least one of the first resources indicated by the first UE that overlaps with the fourth resources is called the fifth resource.

The third condition includes at least one of: a priority corresponding to the fifth resources being greater than a priority of the SL transmission of the second UE;
an offset between the priority corresponding to the fifth resources and the priority of the SL transmission of the second UE being lower than a first threshold;
the priority of the SL transmission of the second UE being lower than a second threshold, and/or the priority corresponding to the fifth resources being greater than a third threshold.

The first UE may indicate multiple SL transmissions based on MCSt, which include transmissions on the fifth resources. For convenience of description, the resources corresponding to the SL transmissions are referred to as sixth resources, and other resources in the sixth resources that do not belong to the fifth resources are referred to as seventh resources.

The third condition further includes: the first UE indicating that the transmissions on the fifth resources are based on MCSt. The condition may also be the first UE indicating that the transmissions on the sixth resources are based on MCSt, and the fifth resources being included in the indicated sixth resources.

The third condition also includes at least one of:
a number of the transmissions based on MCSt indicated by the first UE and/or slots (or other time units) corresponding to the sixth resources being greater than the fourth threshold; at least one of a number of resources included in the fifth resources, a number of slots corresponding to the fifth resources and a number of consecutive slots corresponding to the fifth resources being lower than a fifth threshold;
at least one of a number of resources included in the seventh resources, a number of slots corresponding to the seventh resources, a number of consecutive slots corresponding to the seventh resources, a number of earliest consecutive slots corresponding to the seventh resources, a number of latest consecutive slots corresponding to the seventh resources and a maximum number of the consecutive slots corresponding to the seventh resources being greater than a sixth threshold;
locations of the fifth resources and/or the seventh resources being at least one of: at a starting slot or at least one starting slot or multiple consecutive starting slots of the sixth resources, at an ending slot or at least one ending slot or multiple consecutive ending slots of the sixth resources, and not at at least one starting slot or multiple consecutive starting slots or at least one ending slot or multiple consecutive ending slots of the sixth resources.

At least one/any of the third conditions can be determined whether to be used based on configuration (e.g. higher layer/BS/pre-configuration). If the second UE is configured with multiple third conditions, which third conditions to be used can be further determined according to the LBT type corresponding to the SL transmission on the fourth resources, for example, LBT type 1 or 2, and for another example, LBT type 2A/2B/2C.

The priority corresponding to the fifth resources includes the priority of any or at least one SL transmission on the sixth resources indicated by the first UE, and/or the highest/lowest priority among multiple priorities of any or at least one SL transmission on the sixth resources indicated by the first UE, and/or the priority of any or at least one SL transmission on the fifth resources indicated by the first UE, and/or the highest/lowest priority among priorities of any or at least one SL transmission on the fifth resources indicated by the first UE.

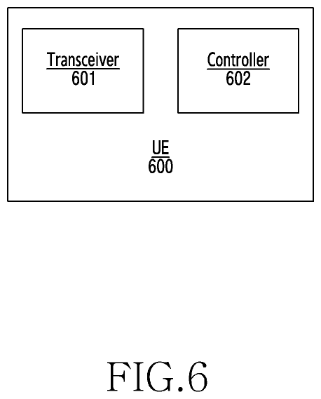

FIG. 6 illustrates a configuration of a UE according to an embodiment.

Referring to FIG. 6, a UE 600 may include a transceiver 601 and a controller 602. For example, the transceiver 601 may be configured to transmit and receive signals. For example, the controller 602 may be coupled to the transceiver 601 and configured to perform the aforementioned methods. Furthermore, the user equipment 600 further includes a memory. Additionally, the components of the user equipment 600 are not limited thereto. For example, the user equipment 600 may include more or fewer components than those described above. In addition, the controller 602 and the transceiver 601 and the memory may be implemented as a single chip. Also, the controller 602 may include at least one processor.

The user equipment 600 may correspond to user equipment of FIG. 3a, the controller 602 may correspond to a processor 340 of FIG. 3a, and the transceiver 601 may correspond to the RF transceiver 310 of FIG. 3a.

The transceiver 601 collectively refers to a UE receiver and a UE transmitter, and may transmit/receive a signal to/from a BS or a network entity. The signal transmitted or received to or from the BS or a network entity may include control information and data. The transceiver 601 may include a RF transmitter for up-converting and amplifying a frequency of a transmitted signal, and a RF receiver for amplifying low-noise and down-converting a frequency of a received signal. However, components of the transceiver 601 are not limited to the RF transmitter and the RF receiver.

Also, the transceiver 601 may receive and output, to the controller 602, a signal through a wireless channel, and transmit a signal output from the controller 602 through the wireless channel.

The memory may store a program and data required for operations of the user equipment 600. Also, the memory may store control information or data included in a signal obtained by the user equipment 600. The memory may be a storage medium, such as ROM, RAM, a hard disk, a CD-ROM, and a DVD, or a combination of storage media.

The controller 602 may control a series of controllers such that the user equipment 600 operates as described above. For example, the transceiver 601 may receive a data signal including a control signal transmitted by the BS or the network entity, and the controller 602 may determine a result of receiving the control signal and the data signal transmitted by the BS or the network entity.

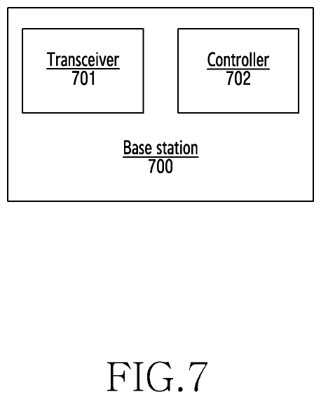

FIG. 7 illustrates a configuration of a BS 700 according to an embodiment.

Referring to FIG. 7, a BS 700 may include a transceiver 701 and a controller 702. For example, the transceiver 701 may be configured to transmit and receive signals. For example, the controller 702 may be coupled to the transceiver 701 and configured to perform the aforementioned methods. The BS 700 further includes a memory. Additionally, the components of the BS 700 are not limited thereto. For example, the BS 700 may include more or fewer components than those described above. In addition, the controller 702 and the transceiver 701 and the memory may be implemented as a single chip. Also, the controller 702 may include at least one processor.

Furthermore, the BS 700 may correspond to gNB of FIG. 3B, the controller 702 may correspond to a processor 378 of FIG. 3B, and the transceiver 701 may correspond to the RF transceiver 372a-372n of FIG. 3B.

The transceiver 701 collectively refers to a BS receiver and a BS transmitter, and may transmit/receive a signal to/from a user equipment or a network entity. The signal transmitted or received to or from the user equipment or a network entity may include control information and data. The transceiver 701 may include a RF transmitter for up-converting and amplifying a frequency of a transmitted signal, and a RF receiver for amplifying low-noise and down-converting a frequency of a received signal. However, this is only a of the transceiver 701 and components of the transceiver 701 are not limited to the RF transmitter and the RF receiver.

The transceiver 701 may receive and output, to the controller 702, a signal through a wireless channel, and transmit a signal output from the controller 702 through the wireless channel.

The memory may store a program and data required for operations of the BS. Also, the memory may store control information or data included in a signal obtained by the BS. The memory may be a storage medium, such as ROM, RAM, a hard disk, a CD-ROM, and a DVD, or a combination of storage media.

The controller 702 may control a series of processes such that the BS operates as described above. For example, the transceiver 701 may receive a data signal including a control signal transmitted by the user equipment, and the controller 702 may determine a result of receiving the control signal and the data signal transmitted by the user equipment.

As described above, a method performed by a first UE in a wireless communication system includes determining first resources for a SL transmission, wherein the first resources include multiple consecutive time units, determining whether the first resources include second resources unavailable for the SL transmission, and performing reselection of at least one of the second resources and at least one of third resources in a case that the first resources include the second resources, wherein the third resources include resources other than the second resources among the first resources, and wherein performing the reselection of at least one of the second resources and at least one of the third resources comprises at least one of: performing reselection of all of the first resources, performing reselection of at least one of the second resources and at least one of the third resources that is located before the at least one of the second resources among the first resources, performing reselection of at least one of the second resources and at least one of the third resources that is located after the at least one of the second resources among the first resources.

Determining whether the first resources include the second resources unavailable for the SL transmission comprises determining whether the first resources include the second resources unavailable for the SL transmission based on whether a first condition is satisfied, wherein the first condition includes at least one of: at least one of the first resources overlapping with resources indicated by other UEs, and at least one of the first resources being unavailable for the SL transmission due to an LBT failure.

Determining whether the first resources include the second resources based on whether the first condition is satisfied comprises determining that at least one of the first resources is the second resource in a case that the at least one of the first resources satisfies the first condition, and determining that the first resources do not include the second resources in a case that any of the first resources does not satisfy the first condition.

When the first condition includes the resources indicated by other UEs overlapping with at least one of the first resources, the first condition further includes at least one of a priority corresponding to the resources indicated by other UEs is greater than a priority of the SL transmission of the first UE, an offset between the priority of the SL transmission of the first UE and the priority corresponding to the resources indicated by other UEs is greater than or equal to a first threshold, the priority corresponding to the resources indicated by other UEs is greater than or equal to a second threshold, the priority of the SL transmission of the first UE is lower than or equal to a third threshold, a number of time units corresponding to the first resources is lower than or equal to a fourth threshold, any of second conditions.

Performing the reselection of at least one of the second resources and at least one of the third resources comprises determining whether to perform the reselection of the at least one of the second resources and the at least one of the third resources based on whether a second condition is satisfied, wherein the second condition is related to a number and/or locations of the second resources and/or the third resources.

The second condition includes at least one of: at least one of a number of resources included in the second resources, a number of time units corresponding to the second resources, and a number of consecutive time units corresponding to the second resources being greater than or equal to a fifth threshold, at least one of a number of resources included in the third resources, a number of time units corresponding to the third resources, a number of consecutive time units corresponding to the third resources, a number of earliest consecutive time units corresponding to the third resources, a number of latest consecutive time units corresponding to the third resources, and a maximum number of the consecutive time units corresponding to the third resources being lower than or equal to a sixth threshold, locations of the second resources and/or the third resources being at least one of: at a starting time unit or at least one starting time unit or multiple consecutive starting time units of the first resources, at an ending time unit or at least one ending time unit or multiple consecutive ending time units of the first resources, and not at the starting time unit or at least one starting time unit or multiple consecutive starting time units of the first resources or the ending time unit or at least one ending time unit or multiple consecutive ending time units of the first resources.

Determining whether to perform the reselection of the at least one of the second resources and the at least one of the third resources based on whether the second condition is satisfied comprises determining to perform the reselection of the at least one of the second resources and the at least one of the third resources and to transmit the SL transmission on the reselected resources and resources on which the reselection is not performed among the first resources, in a case that the second condition is satisfied, and determining not to perform the reselection of the at least one of the second resources and the at least one of the third resources and to transmit the SL transmission on the first resources, in a case that the second condition is not satisfied.

Performing the reselection comprises at least one of preferentially selecting candidate resources on consecutive time units, preferentially selecting candidate resources that are continuous in time with other selected resources, wherein the selected resources include resources on which the reselection is not performed among the first resources, and/or resources other than the first resources that are selected by the first UE for the SL transmission.

Performing the reselection comprises at least one of if candidate resources are before selected resources, and a gap between a starting location of the candidate resources and a time point at which the first UE is triggered to perform the reselection or a time point at which the first UE determines that the second resources are included or a time point at which the first UE determines to perform the reselection of the at least one of the second resources and the at least one of the third resources is greater than or equal to a seventh threshold, selecting the candidate resources, if the candidate resources are after the selected resources, and the gap between the starting location of the candidate resources and the time point at which the first UE is triggered to perform the reselection or the time point at which the first UE determines that the second resources are included or the time point at which the first UE determines to perform the reselection of the at least one of the second resources and the at least one of the third resources is greater than or equal to the seventh threshold, selecting the candidate resources, if the candidate resources are after the selected resources, and the candidate resources are within a time range of channel occupancy initiated or shared by the first UE, selecting the candidate resources, if the candidate resources are outside the time range of the channel occupancy initiated or shared by the first UE, when a time gap between the candidate resources and other resources selected by the first UE and/or resources indicated by other UEs that are detected by the first UE is greater than or equal to an eighth threshold, selecting the candidate resources, if the second resources are unavailable for the SL transmission due to an LBT failure, excluding all candidate resources on a time unit for the LBT failure and/or a time unit where a resource corresponding to the LBT failure is located.

When determining not to perform the reselection of the at least one of the second resources and the at least one of the third resources and to transmit the SL transmission on the first resources, the method further comprises at least one of: transmitting signaling to other UEs to indicate the other UEs to reselect resources, in a case that the second resources overlap with resources indicated by the other UEs, indicating a priority of the SL transmission in SL control information (SCI) associated with the SL transmission.

The indicated priority is determined by at least one of if a priority corresponding to the SL transmission is lower than or equal to a ninth threshold, setting the indicated priority as the ninth threshold, otherwise setting the indicated priority as the priority corresponding to the SL transmission, setting the indicated priority as the priority corresponding to the SL transmission plus an offset, if transmissions included in the SL transmissions correspond to multiple priorities, setting the indicated priority of each or at least one of the SL transmissions as a highest priority or a lowest priority among the multiple priorities.

The signaling indicates at least one of the first resources, the second resources and the third resources, whether the SL transmission of the first UE is based on an MCSt, a priority corresponding to at least one of the first resources, the second resources and the third resources.

As described above, a method performed by a second UE in a wireless communication system, comprising determining fourth resources for an SL transmission, and determining whether to perform reselection of the fourth resources according to whether a third condition is satisfied, based on detecting that fifth resources overlap with the fourth resources, wherein the fifth resources include at least one of first resources indicated by a first UE, wherein the third condition is related to a priority of the fifth resources and/or the SL transmission of the second UE and/or whether the SL transmission is based on an MCSt.

The third condition includes at least one of the priority corresponding to the fifth resources being greater than the priority of the SL transmission of the second UE, an offset between the priority corresponding to the fifth resources and the priority of the SL transmission of the second UE being lower than a first threshold, the priority of the SL transmission of the second UE being lower than a second threshold, the priority corresponding to the fifth resources being greater than a third threshold, the first UE indicating that the SL transmission on the fifth resources is based on the MCSt, the first UE indicating that the SL transmission on sixth resources is based on the MCSt, and the fifth resources being included in the sixth resources, wherein the sixth resources include resources corresponding to multiple SL transmissions based on the MCSt.

Determining whether to perform the reselection of the fourth resources according to whether the third condition is satisfied comprises performing the reselection of the fourth resources and transmitting the SL transmission on the reselected fourth resources, in a case that the third condition is satisfied.

When the third condition includes the first UE indicating that the SL transmission on the fifth resources is based on the MCSt, and/or the first UE indicating that the SL transmission on the sixth resources is based on the MCSt and the fifth resources are included in the sixth resources, the third condition further includes at least one of: a number of time units corresponding to the SL transmission based on the MCSt indicated by the first UE and/or the sixth resources being greater than a fourth threshold, at least one of a number of resources included in the fifth resources, a number of time units corresponding to the fifth resources and a number of consecutive time units corresponding to the fifth resources being lower than a fifth threshold, at least one of a number of resources included in the seventh resources, a number of time units corresponding to the seventh resources, a number of consecutive time units corresponding to the seventh resources, a number of earliest consecutive time units corresponding to the seventh resources, a number of latest consecutive time units corresponding to the seventh resources and a maximum number of the consecutive time units corresponding to the seventh resources being greater than a sixth threshold, wherein the seventh resources include resources other than the fifth resources among the sixth resources, locations of the fifth resources and/or the seventh resources being at least one of: at a starting time unit or at least one starting time unit or multiple consecutive starting time units of the sixth resources, at an ending time unit or at least one ending time unit or multiple consecutive ending time units of the sixth resources, and not at the starting time unit or at least one starting time unit or multiple consecutive starting time units of the sixth resources or the ending time unit or at least one ending time unit or multiple consecutive ending time units of the sixth resources.

As described above a UE includes a transceiver configured to transmit and receive signals, and a controller coupled to the transceiver and configured to perform the method of any of claims.

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the invention of the disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a digital signal processor (DSP), an application specific integrated circuit (ASIC), a field programmable gate array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, more than one microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. An exemplary storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more exemplary designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a first user equipment (UE) in a wireless communication system, comprising:
determining first resources for a sidelink (SL) transmission, the first resources including multiple consecutive time units;
determining whether the first resources include second resources unavailable for the SL transmission; and
performing reselection of at least one of the second resources and at least one of third resources in a case that the first resources include the second resources,
wherein the third resources include resources other than the second resources among the first resources, and
wherein performing the reselection of at least one of the second resources and at least one of the third resources comprises at least one of:
performing reselection of all of the first resources,
performing reselection of at least one of the second resources and at least one of the third resources that is located before the at least one of the second resources among the first resources, and
performing reselection of at least one of the second resources and at least one of the third resources that is located after the at least one of the second resources among the first resources.

2. The method of claim 1, wherein determining whether the first resources include the second resources unavailable for the SL transmission comprises:
determining whether the first resources include the second resources unavailable for the SL transmission based on whether a first condition is satisfied, the first condition including at least one of:
at least one of the first resources overlapping with resources indicated by other UEs, and
at least one of the first resources being unavailable for the SL transmission due to a listen before talk (LBT) failure.

3. The method of claim 2, wherein determining whether the first resources include the second resources based on whether the first condition is satisfied comprises:
determining that at least one of the first resources is the second resource in a case that the at least one of the first resources satisfies the first condition; and
determining that the first resources do not include the second resources in a case that any of the first resources does not satisfy the first condition.

4. The method of claim 2, wherein in a case that the first condition includes the resources indicated by other UEs overlapping with at least one of the first resources, the first condition further includes at least one of:
a priority corresponding to the resources indicated by other UEs is greater than a priority of the SL transmission of the first UE,
an offset between the priority of the SL transmission of the first UE and the priority corresponding to the resources indicated by other UEs is greater than or equal to a first threshold,
the priority corresponding to the resources indicated by other UEs is greater than or equal to a second threshold,
the priority of the SL transmission of the first UE is lower than or equal to a third threshold,
a number of time units corresponding to the first resources is lower than or equal to a fourth threshold, or
any of second conditions.

5. The method of claim 4, wherein the second condition includes at least one of:
at least one of a number of resources included in the second resources, a number of time units corresponding to the second resources, and a number of consecutive time units corresponding to the second resources being greater than or equal to a fifth threshold,
at least one of a number of resources included in the third resources, a number of time units corresponding to the third resources, a number of consecutive time units corresponding to the third resources, a number of earliest consecutive time units corresponding to the third resources, a number of latest consecutive time units corresponding to the third resources, and a maximum number of the consecutive time units corresponding to the third resources being lower than or equal to a sixth threshold, and
locations of the second resources and/or the third resources being at least one of at a starting time unit or at least one starting time unit or multiple consecutive starting time units of the first resources, at an ending time unit or at least one ending time unit or multiple consecutive ending time units of the first resources, and not at the starting time unit or at least one starting time unit or multiple consecutive starting time units of the first resources or the ending time unit or at least one ending time unit or multiple consecutive ending time units of the first resources.

6. The method of claim 1, wherein performing the reselection of at least one of the second resources and at least one of the third resources comprises:
determining whether to perform the reselection of the at least one of the second resources and the at least one of the third resources based on whether a second condition is satisfied, the second condition being related to a number and/or locations of the second resources and/or the third resources.

7. The method of claim 6, wherein the second condition includes at least one of:
at least one of a number of resources included in the second resources, a number of time units corresponding to the second resources, and a number of consecutive time units corresponding to the second resources being greater than or equal to a fifth threshold,
at least one of a number of resources included in the third resources, a number of time units corresponding to the third resources, a number of consecutive time units corresponding to the third resources, a number of earliest consecutive time units corresponding to the third resources, a number of latest consecutive time units corresponding to the third resources, and a maximum number of the consecutive time units corresponding to the third resources being lower than or equal to a sixth threshold, and
locations of the second resources and/or the third resources being at least one of: at a starting time unit or at least one starting time unit or multiple consecutive starting time units of the first resources, at an ending time unit or at least one ending time unit or multiple consecutive ending time units of the first resources, and not at the starting time unit or at least one starting time unit or multiple consecutive starting time units of the first resources or the ending time unit or at least one ending time unit or multiple consecutive ending time units of the first resources.

8. The method of claim 7, wherein determining whether to perform the reselection of the at least one of the second resources and the at least one of the third resources based on whether the second condition is satisfied comprises:
determining to perform the reselection of the at least one of the second resources and the at least one of the third resources and to transmit the SL transmission on the reselected resources and resources on which the reselection is not performed among the first resources, in a case that the second condition is satisfied; and
determining not to perform the reselection of the at least one of the second resources and the at least one of the third resources and to transmit the SL transmission on the first resources, in a case that the second condition is not satisfied.

9. The method of claim 6, wherein determining whether to perform the reselection of the at least one of the second resources and the at least one of the third resources based on whether the second condition is satisfied comprises:
determining to perform the reselection of the at least one of the second resources and the at least one of the third resources and to transmit the SL transmission on the reselected resources and resources on which the reselection is not performed among the first resources, in a case that the second condition is satisfied; and
determining not to perform the reselection of the at least one of the second resources and the at least one of the third resources and to transmit the SL transmission on the first resources, in a case that the second condition is not satisfied.

10. The method of claim 1, wherein performing the reselection comprises at least one of:
preferentially selecting candidate resources on consecutive time units, and preferentially selecting candidate resources that are continuous in time with other selected resources, wherein the selected resources include resources on which the reselection is not performed among the first resources, and/or resources other than the first resources that are selected by the first UE for the SL transmission.

11. The method of claim 1, wherein performing the reselection comprises at least one of:
if candidate resources are before selected resources, and a gap between a starting location of the candidate resources and a time point at which the first UE is triggered to perform the reselection or a time point at which the first UE determines that the second resources are included or a time point at which the first UE determines to perform the reselection of the at least one of the second resources and the at least one of the third resources is greater than or equal to a seventh threshold, selecting the candidate resources,
if the candidate resources are after the selected resources, and the gap between the starting location of the candidate resources and the time point at which the first UE is triggered to perform the reselection or the time point at which the first UE determines that the second resources are included or the time point at which the first UE determines to perform the reselection of the at least one of the second resources and the at least one of the third resources is greater than or equal to the seventh threshold, selecting the candidate resources,
if the candidate resources are after the selected resources, and the candidate resources are within a time range of channel occupancy initiated or shared by the first UE, selecting the candidate resources,
if the candidate resources are outside the time range of the channel occupancy initiated or shared by the first UE, when a time gap between the candidate resources and other resources selected by the first UE and/or resources indicated by other UEs that are detected by the first UE is greater than or equal to an eighth threshold, selecting the candidate resources, and
if the second resources are unavailable for the SL transmission due to an LBT failure, excluding all candidate resources on a time unit for the LBT failure and/or a time unit where a resource corresponding to the LBT failure is located.

12. The method of claim 7, wherein in a case of determining not to perform the reselection of the at least one of the second resources and the at least one of the third resources and to transmit the SL transmission on the first resources, the method further comprises at least one of:
transmitting signaling to other UEs to indicate the other UEs to reselect resources, in a case that the second resources overlap with resources indicated by the other UEs, and
indicating a priority of the SL transmission in SL control information (SCI) associated with the SL transmission.

13. The method of claim 12, wherein the indicated priority is determined by at least one of:
if a priority corresponding to the SL transmission is lower than or equal to a ninth threshold, setting the indicated priority as the ninth threshold, otherwise setting the indicated priority as the priority corresponding to the SL transmission,
setting the indicated priority as the priority corresponding to the SL transmission plus an offset, and
if transmissions included in the SL transmissions correspond to multiple priorities, setting the indicated priority of each or at least one of the SL transmissions as a highest priority or a lowest priority among the multiple priorities.

14. The method of claim 12, wherein the signaling indicates at least one of:
at least one of the first resources, the second resources and the third resources,
whether the SL transmission of the first UE is based on a multi-consecutive slots transmission (MCSt),
a priority corresponding to at least one of the first resources, the second resources and the third resources.

15. A method performed by a second user equipment (UE) in a wireless communication system, comprising:
determining fourth resources for a sidelink (SL) transmission; and
determining whether to perform reselection of the fourth resources according to whether a third condition is satisfied, based on detecting that fifth resources overlap with the fourth resources, wherein the fifth resources include at least one of first resources indicated by a first UE,
wherein the third condition is related to a priority of the fifth resources and/or the SL transmission of the second UE and/or whether the SL transmission is based on a multi-consecutive slots transmission (MCSt).

16. The method of claim 15, wherein the third condition includes at least one of:
the priority corresponding to the fifth resources being greater than the priority of the SL transmission of the second UE,
an offset between the priority corresponding to the fifth resources and the priority of the SL transmission of the second UE being lower than a first threshold,
the priority of the SL transmission of the second UE being lower than a second threshold,
the priority corresponding to the fifth resources being greater than a third threshold, the first UE indicating that the SL transmission on the fifth resources is based on the MCSt,
the first UE indicating that the SL transmission on sixth resources is based on the MCSt, and the fifth resources being included in the sixth resources, wherein the sixth resources include resources corresponding to multiple SL transmissions based on the MCSt.

17. The method of claim 16, wherein in a case that the third condition includes the first UE indicating that the SL transmission on the fifth resources is based on the MCSt, and/or the first UE indicating that the SL transmission on the sixth resources is based on the MCSt and the fifth resources are included in the sixth resources, the third condition further includes at least one of:
a number of time units corresponding to the SL transmission based on the MCSt indicated by the first UE and/or the sixth resources being greater than a fourth threshold,
at least one of a number of resources included in the fifth resources, a number of time units corresponding to the fifth resources and a number of consecutive time units corresponding to the fifth resources being lower than a fifth threshold,
at least one of a number of resources included in the seventh resources, a number of time units corresponding to the seventh resources, a number of consecutive time units corresponding to the seventh resources, a number of earliest consecutive time units corresponding to the seventh resources, a number of latest consecutive time units corresponding to the seventh resources and a maximum number of the consecutive time units corresponding to the seventh resources being greater than a sixth threshold, wherein the seventh resources include resources other than the fifth resources among the sixth resources, and
locations of the fifth resources and/or the seventh resources being at least one of: at a starting time unit or at least one starting time unit or multiple consecutive starting time units of the sixth resources, at an ending time unit or at least one ending time unit or multiple consecutive ending time units of the sixth resources, and not at the starting time unit or at least one starting time unit or multiple consecutive starting time units of the sixth resources or the ending time unit or at least one ending time unit or multiple consecutive ending time units of the sixth resources.

18. The method of claim 15, wherein determining whether to perform the reselection of the fourth resources according to whether the third condition is satisfied comprises:
performing the reselection of the fourth resources and transmitting the SL transmission on the reselected fourth resources, in a case that the third condition is satisfied.

19. A user equipment (UE), comprising:
a transceiver configured to transmit and receive signals; and
a controller coupled to the transceiver and configured to:
determine first resources for a sidelink (SL) transmission, wherein the first resources include multiple consecutive time units;
determine whether the first resources include second resources unavailable for the SL transmission; and
perform reselection of at least one of the second resources and at least one of third resources in a case that the first resources include the second resources,
wherein the third resources include resources other than the second resources among the first resources, and
wherein performing the reselection of at least one of the second resources and at least one of the third resources comprises at least one of:
performing reselection of all of the first resources,
performing reselection of at least one of the second resources and at least one of the third resources that is located before the at least one of the second resources among the first resources, and
performing reselection of at least one of the second resources and at least one of the third resources that is located after the at least one of the second resources among the first resources.

20. A user equipment (UE) comprising:
a transceiver configured to transmit and receive signals; and
a controller coupled to the transceiver and configured to:
determine fourth resources for a sidelink (SL) transmission; and
determine whether to perform reselection of the fourth resources according to whether a third condition is satisfied, based on detecting that fifth resources overlap with the fourth resources, wherein the fifth resources include at least one of first resources indicated by a first UE,
wherein the third condition is related to a priority of the fifth resources and/or the SL transmission of the second UE and/or whether the SL transmission is based on a multi-consecutive slots transmission (MCSt).
